(19) United States
(12) Patent Application Publication
(10) Pub. No.: US 2023/0166358 A1
(43) Pub. Date: Jun. 1, 2023

(54) METHOD FOR OPERATING AND CONTROLLING A LASER DEVICE FOR ENGRAVING, MARKING, LETTERING AND/OR CUTTING A PREFERABLY FLAT WORKPIECE

(71) Applicant: Trotec Laser GmbH, Marchtrenk (AT)

(72) Inventor: Alexander JAUKER, Neuhofen an der Krems (AT)

(21) Appl. No.: 17/920,707

(22) PCT Filed: Mar. 16, 2021
(86) PCT No.: PCT/AT2021/060089

§ 371 Date: Oct. 21, 2022

(30) Foreign Application Priority Data
Apr. 24, 2020 (AT) A50355/2020

(51) Int. Cl. B23K 26/38; B23K 26/06; B23K 26/082; B23K 26/08; B23K 26/352; B23K 26/362

(52) U.S. Cl. CPC B23K 26/38; B23K 26/0626; B23K 26/082; B23K 26/0869; B23K 26/352; B23K 26/362

(57) ABSTRACT

The present disclosure relates to a method for operating and controlling a laser device for engraving, marking, lettering and/or cutting a flat workpiece, in which at least one beam source in the form of a laser is used in a housing of the laser device. The workpiece is deposited in a defined manner on a processing table in the processing chamber of the housing and a laser beam emitted by the beam source is sent via deflecting elements to at least one focusing unit, from which the laser beam is deflected in the direction of the workpiece and focused for processing. Control is effected by means of control software which runs in a control unit and in which a so-called job is processed, so that the workpiece is processed line by line by adjustment of a movement system.

The present invention relates to a method for operating and controlling a laser device for engraving, marking, lettering and/or cutting a preferably flat workpiece, in which at least one beam source in the form of a laser is used in a housing of the laser device, wherein the workpiece is deposited in a defined manner on a processing table in the processing chamber of the housing and a laser beam emitted by the beam source and sent via deflecting elements to at least one focusing unit, from which the laser beam is deflected in the direction of the workpiece and focused for processing, wherein control, in particular the position control of the workpiece relative to the laser beam, is effected by means of control software which runs in a control unit and in which a so-called job is processed, so that the workpiece is processed preferably line by line by adjustment of a movement system, such as a carriage in the case of a laser plotter or an angular adjustment in the case of a galvo marking laser, as described in claim 1.

In laser devices, in particular laser plotters and galvo marking lasers, the laser light is guided from a laser source via deflecting elements to a focusing unit, wherein the laser beam is sharply focused by a focusing lens and deflected in the direction of the workpiece to be processed. Thus, in the focus of the laser beam an extremely high power density is produced, with which materials can be melted or evaporated, engraved, or lettered. The processing, in particular the engraving, is carried out line by line, for which various laser devices or systems, respectively, are used or employed, respectively.

On the one hand, a laser plotter is used in which the focusing unit is mounted on a carriage that is preferably adjusted by a belt drive. The focusing unit is also arranged on the carriage so that it can be moved. Thus, by adjusting the carriage and the focusing unit, a processing chamber, in particular a processing table on which the workpiece is placed, can be completely processed.

On the other hand, gravo marking devices are known from the art whose focusing unit also has a focusing lens for bundling the laser beam, wherein the focusing unit is preferably positioned centrally above the processing chamber. In order to be able to process the entire processing chamber with the bundled and focused laser beam, the gravo marking devices have an adjustable mirror in the focusing unit that can deflect the laser beam to any position in the defined processing chamber.

The main difference between these two device types, i.e. between a laser plotter and a gravo marking laser, is thus the position or movement control, respectively, for the laser beam.

The disadvantage is that for each device type a separate job must be created for processing the workpiece, in which the parameters, such as position or movement data, respectively, for creating a graphic or text, respectively, focus point, power, tool thickness, tool material, etc., must be created. I.e., if a graphic or text is to be engraved on several workpieces both on the laser plotter and with the gravo marking device, two different jobs, namely a laser plotter job and a gravo job, must be created for the processing, which are then loaded into the relevant device types.

For job creation, the graphics or texts, respectively, are usually created on suitable software, such as Corel Draw, Paint, etc., and then imported into the respective software for the laser plotter and/or the gravo marking laser, whereupon the further setting of the parameters, such as tool material, tool thickness, etc., must be set in the respective software, so that a job can then be generated, which is loaded into the respective laser type.

The objective of the present invention is to create a method and a laser plotter in which, on the one hand, the above-mentioned disadvantages are avoided and, on the other hand, user-friendliness is substantially increased.

The objective is achieved by the invention.

The objective of the present invention is achieved by the job for the workpiece processing being downloaded from a web-based database or cloud, respectively, directly by the laser device or the laser unit, respectively, or alternatively a component, such as computer, laptop, cell phone, tablet, etc., wherein the location of the laser device is determined or queried, respectively, before the start of the download or during the download, whereupon the applicable policies for the safety settings and, if necessary, further settings or parameters, respectively, for the determined location, in particular the country or region, respectively, are determined and the associated parameters, in particular so-called safety parameters, are checked in the job and adjusted if necessary.

The advantage here is that by automatic adaptation of parameters depending on the location, the job creation can be created independently of the applicable policies of the safety settings. It is therefore possible, for example, to create a job in Austria for a company in the USA, whereupon the job in the USA is downloaded and automatically adapted to the policies applicable there. This eliminates the need for the creator of a job to know the applicable regulations for the country in which the job is being processed, as these are automatically loaded and adjusted during the download from the cloud or web-based database, respectively. When the job is started, the laser unit first automatically checks the setting or configuration, respectively, of the system in order to ensure that all components are present and that the job can be carried out according to the specified and updated policies, i.e., for example, when the job is started with the setting “Extraction with filter”, the laser device first checks whether or not a filter is present, and in case of noncompliance a warning message appears and the job is not started. This warning message can be acknowledged, for example, by an authorized person by way of a special release, in particular by entering a password or code, but this is stored by the laser unit for warranty purposes, since improper processing voids the warranty policy. For this purpose, it is also possible to store this manual release in the cloud.

Advantageous embodiments are such in which the adaptation of the job for the policies of the safety setting comprises the parameter “suction power” and/or “extraction with filter”.

This ensures that safe operation of the system or laser, respectively, is possible.

However, advantageous embodiments are also such where the adaptation of the job for the policies of the safety setting includes the parameter “filter saturation”. This allows optimal adjustment of the system to the specified policies.

Further advantageous embodiments are such in which in which the existing equipment or components, respectively, are checked with the parameters for the safety settings when the downloaded job is started on the laser device. Thus, the operators do not need to have any special technical knowledge, as the system or the laser, respectively, automatically checks whether all components are present and whether the parameters are set accordingly, so that the laser unit is operated in compliance with the policies.

Advantageous embodiments are such in which a warning is issued and the job is not started in the event of deviations of the determined equipment or components, respectively, with the specified settings of the parameters. This alerts the operator that the system is not operating in compliance with the policy, and the operator must make appropriate adjustments.

Advantageous embodiments are such in which, when a warning is present, a special release by an authorized person is required, where a confirmation preferably requires an input of a code or password, respectively, to start the job. This allows an urgent job to be processed at short notice, wherein, however, appropriate documentation of such releases is automatically stored by the laser unit.

Advantageous embodiments are such in which the release of the job is documented and stored despite the goods note preferably for the warranty policy of the manufacturer, wherein preferably the storage is done in the cloud or in the web-based database, respectively. This ensures that if any problems occur with the laser unit, it can be tracked at any time whether or not the laser unit was being operated according to specifications.

Further advantageous embodiments are such in which, in order to create the job, the latter is generated by a central operator software for various laser types, in particular laser plotter or galvo marking laser, for engraving, marking, lettering, and/or cutting of a preferably flat workpiece, wherein in the central operator software a graphic and/or text is created or imported, whereupon in the central operator software for the creation of the job the parameters “material type, material thickness, engraving depth and effect” are set, whereupon a laser type—laser plotter or galvo marking laser—is suggested or determined, respectively, by the operator software, or the desired laser type—laser plotter or galvo marking laser—is selected by the user, whereupon, after selection of the laser type, the movement parameters of the selected laser type required for the generation of the graphics and/or text are determined or calculated, respectively, and defined by an analysis tool and, after completion of the job, this is stored in a web-based database or cloud, respectively. This makes it possible for the first time that a job can be created with one software for a wide variety of laser units. This means that the operator no longer needs skills with different softwares for the various device types, but only needs to be able to operate this one central operator software. A significant advantage is also that at any time another laser unit, which is currently free, can be selected, as the job is automatically adapted. Thus, the user does not have to decide which laser unit to use when creating the job.

Advantageous embodiments are such in which the central operator software is invoked via a higher-level network, in particular in a cloud, wherein the available laser types, in particular laser units, are likewise connected or being connected, respectively, to the cloud, wherein it is preferably possible to display or query their status, respectively. This ensures that the cloud is also used for operator software and for job storage and management.

Further advantageous embodiments are such in which the determined policies for the individual locations, in particular countries or regions, respectively, are stored in a web-based database or in the cloud, respectively. This ensures that all the necessary information can be accessed and downloaded centrally in the cloud from anywhere in the world, as is also the case for the jobs and operator software.

Further advantageous embodiments are such in which the job is loaded and processed simultaneously by one or more laser plotters of the same and different locations. This makes it possible for larger quantities to be processed in parallel with different lasers. Advantageous embodiments are such in which, when the job is changed on one laser plotter, these changes are made available to the further laser plotters processing this job, in particular they are displayed. This ensures that anyone using the job can see what adjustments are being made or have been made, respectively, to optimize the job, so that they can adopt them as well. It is possible that a corresponding history is stored and saved for the jobs in order to be able to track the changes.

Finally, advantageous embodiments are such where when a laser plotter is connected to the web-based database, all settings/parameters and location pertaining to that laser plotter are automatically uploaded and saved. This allows the operator software to set precise parameters when selecting this laser unit.

The invention is described hereinafter in the form of exemplary embodiments, wherein attention is drawn to the fact that the invention is not limited to the exemplary embodiments or solutions, respectively, represented and described.

The figures show:

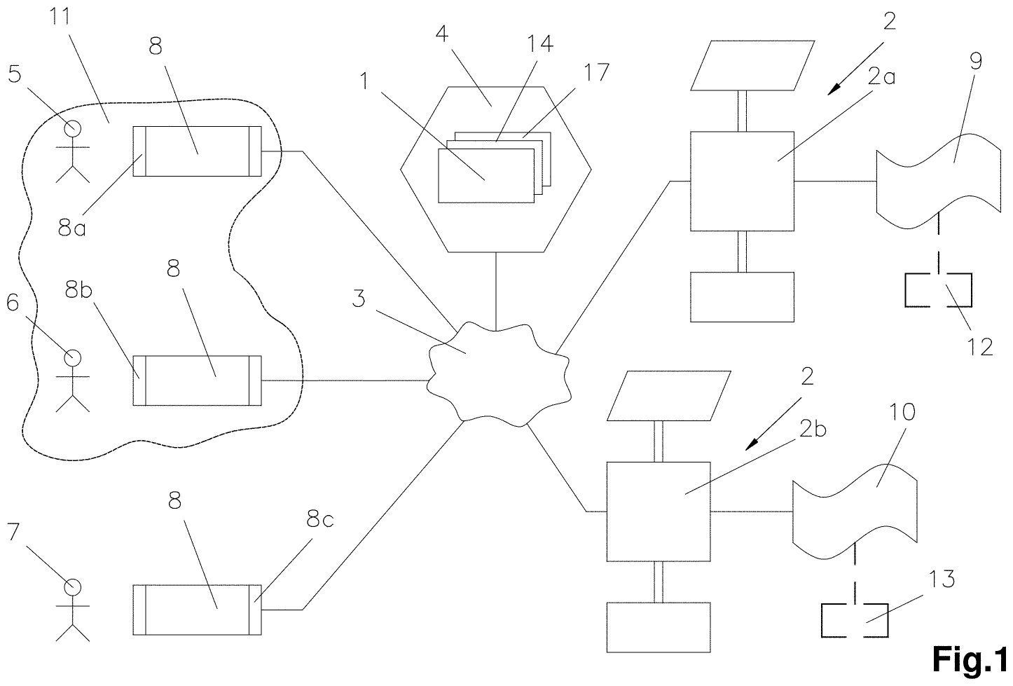

FIG. 1 a schematic illustration of the method for generating a job via a central operator software for various laser types or laser units, respectively, simplified, for illustrative purposes only;

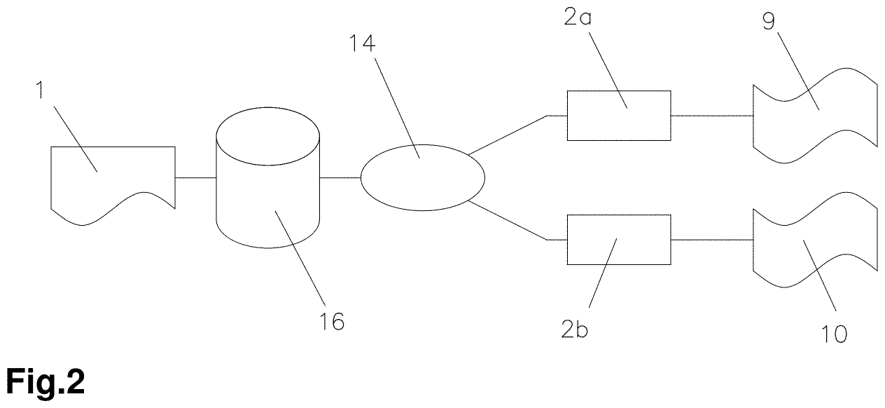

FIG. 2 a schematic illustration of a workflow for the creation of a job from a central operator software for various laser types, simplified, for illustrative purposes only;

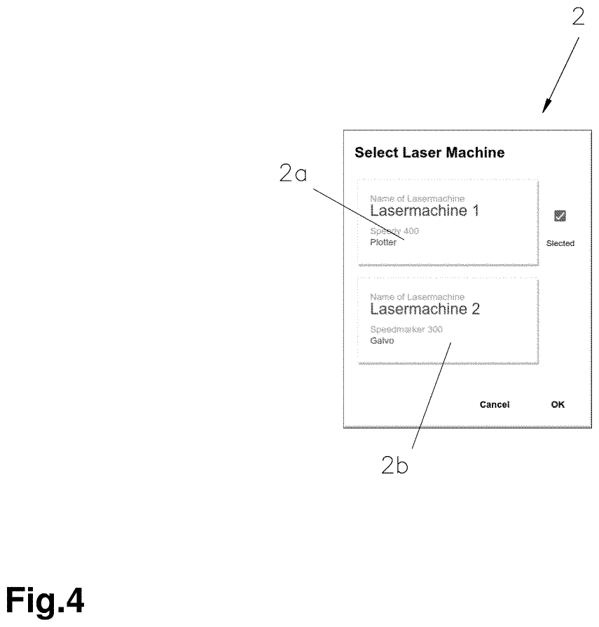

FIG. 4 a screenshot of the user interface, simplified, for illustrative purposes only;

FIG. 5 a further screenshot of the user interface, simplified, for illustrative purposes only.

It should be stated by way of introduction that, in the individual embodiments, the same parts are provided with the same reference numbers or same component designations, respectively, wherein the disclosures contained in the entire description can, by analogy, be transferred to identical parts with identical reference numbers or identical component designations, respectively. The position details selected in the description, such as, e.g., top, bottom, lateral, etc., likewise relate to the figure described, and in the event of a change of position, they are to be transferred to the new position by analogy. Individual features or feature combinations from the exemplary embodiments shown and described may also represent independent inventive solutions.

In FIGS. 1 to 4 a process flow for a central operator software 1 is shown, which is used for various laser devices or laser units 2, respectively. Here, the operator software 1 is used on the one hand for so-called laser plotters 2a and on the other hand for so-called galvo marking lasers 2b.

I.e., a user creates and uses a job for processing a workpiece with the same operator software 1.

Preferably, the operator software 1 has a web-based structure, so that it is installed in a cloud 4 via the internet 3. In this case, a user 5,6,7 can access it via a web browser 8 by entering the address via the internet 3, so that the user interface of the operator software 1 is displayed in the browser 8 and corresponding input can be made to create a job 9,10 for a wide variety of laser units 2, in particular laser plotters 2a and/or galvo marking lasers 2b. Preferably, each user 5-7 has a personal login, so that a corresponding assignment can be made easily. Advantageously, several manufacturers or companies 11, respectively, can create a company login or company network 11, respectively, so that several users 5,6 of a company can individually or simultaneously access the central operator software 1 and thereby see all laser devices 2 or laser units 2, respectively, assigned to this company. In this case, company-related laser units 2 are not publicly visible, so that only users 5,6 of this company network who have the appropriate authorization can see and address these laser units 2 via the central operator software 1. It is of course possible for an authorized user 5,6, in particular an administrator 5, of the company network 11 to make one or more laser units 2 publicly accessible, so that corresponding jobs 9, 10 are also sent by external users 7 to these laser units 2 for a commissioned job.

As can now be seen from FIG. 1, a user 5-7 connects to the internet 3 and subsequently to the central operator software 1 in the cloud 4 via the browser 8, which can be opened on a laptop 8a, computer, tablet 8b or cell phone 8c, for example. Here, a user 5-7 enters an appropriate internet address, in particular a so-called IP address, so that a connection is established. The user interface of the central operator software 1 is then displayed in the browser 8. The user 5-7 can now use the operator software 1 normally, as if it were installed on his component, for example the laptop 8a, the computer, the tablet 8b, or the cell phone 8c.

To enable the users 5-7 to also to select the available laser units 2 via the central operator software 1, the laser units 2 are equipped with corresponding components, in particular a network card, so that by connecting a laser unit 2 to the internet 3, this laser unit 2 can be registered and configured in the cloud 4, in particular the central operator software 1. Thereby, the laser units 2 can be configured in such a way that they are publicly visible or visible only in the own company's network 11.

According to the present invention, it is now envisioned that all laser units 2 of different designs, i.e. all laser plotters 2a and galvo marking lasers 2b, are connected to the central operator software 1 and can also be selected. In this case, the operator software 1 creates both a job 9 for a laser plotter 2a and a job 10 for a galvo marking laser 2b, whereas in the prior art two different softwares are required for this purpose. This ensures that the user 5-7 needs to operate only one user interface to create a job 9,10 for one or both laser types. For the sake of completeness, it is mentioned that in the laser units at least one beam source in the form of a laser is used in a housing, wherein a workpiece 12, 13 is deposited in a defined manner on a processing table in the processing chamber of the housing and a laser beam emitted by the beam source is sent via deflecting elements to at least one focusing unit, from which the laser beam is deflected in the direction of the workpiece and focused for processing. Control, in particular the position control of the workpiece with respect to the laser beam, is carried out by means of a control software running in a control unit in which the job 9 or 10 is processed, so that the workpiece is preferably processed line by line by adjusting a movement system, such as a carriage in the case of a laser plotter 2a or an angular adjustment in the case of a galvo marking laser 2b. The two laser units 2 differ particularly in the motion control and the focusing lens used, in particular regarding the beam diameter.

These essential differences are thereby taken into account by an analysis tool 14 during the creation of the job 9,10.

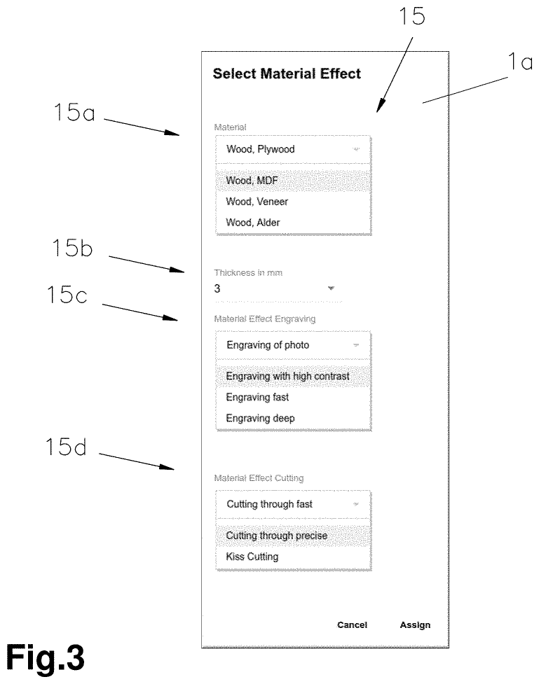

For a job 9 and/or 10 now to be created, a user 5-7 must create or import only its diagram, respectively, and/or picture or the text and set some few parameters 15. For increased user-friendliness, the user 5-7 needs to enter only four parameters 15, namely:
15a Material of the workpiece
15b Thickness of the workpiece
15c Effect for engraving or engraving depth, respectively
15d Cutting effect
   as shown schematically in FIG. 3 by illustrating a screen interface of the operator software. Thus, even untrained employees or so-called laymen are enabled to make the setting of the parameters 15. For this purpose, the user 5-7 creates or imports a graphic and/or text in the central operator software 1, whereupon the parameters “material 15a, material thickness 15b, engraving depth or effect 15c, respectively, and cutting effect 15d” are set in the central operator software 1 for creation of the job 9 or 10. Subsequently, the operator software 1 suggests or determines, respectively, a laser type—laser plotter 2a or galvo marking laser 2b—or the user selects the desired laser type—laser plotter or galvo marking laser—as shown in FIG. 4 of an excerpt from the user interface 1a, whereupon, after selection of the laser type 2, the movement parameters of the selected laser type 2 required for the generation of the graphics and/or text are determined or calculated, respectively, and specified by the analysis tool 14, whereupon the laser power and speed are calculated and specified by the analysis tool 14 and the job 9 or 10 is created. Such a workflow is shown schematically in FIG. 2. Of course, it is possible for the user 5-7 to change any parameter 15.

It is possible for the operator software 1 and/or the analysis tool 14 to access a database 16, in particular a material database, in which further parameters 15 for processing a wide variety of materials are stored. Furthermore, other safety-relevant parameters 15 may be stored in this database 16, which are also taken into account by the analysis tool 14. For this purpose, machine-related data, such as lenses used, filter type, etc., are also stored, which are essential for the creation and selection of the laser unit 2. Of course, it is also possible for such machine-related data to be queried online directly by the analysis tool 14 from the respective laser units 2 via the internet connection. In particular, this is used whenever the user 5-7 selects a particular laser unit 2 that the analysis tool 14 accesses during creation and calculation of the job 9,10 and queries the relevant data. Among other things, the analysis tool 14 also takes into account the lenses used in the laser units 2 and the resulting beam diameters, i.e., if a laser unit 2 is selected and the resolution or quality, respectively, is too high and cannot be achieved by a beam diameter that is too thick, a message appears indicating that the selected quality cannot be achieved, or that another laser unit should be selected to achieve the quality.

Thus, it can be said that the customer or user 5-7, respectively, can perform all steps relevant to the creation of a workpiece 13,14 in the central web-based operator software 1, to which he or she can connect via a browser 8, wherein no additional software packages are required. By mapping a holistic system, work steps are optimized for each other, and interface inefficiencies completely eliminated. Laser population with process and work parameters is possible from a single point of contact, namely the cloud 4. Job data can be managed here and directly assigned to a respective laser or laser unit 2, respectively, and also started. For this purpose, a job database 17 can be populated directly, in which the created jobs 9, 10 for all laser units 2, i.e. for laser plotter 2a and galvo marking laser 2b, are stored. It is also possible to have order data transmitted via various attributes.

Thanks to the integration of the job database 17 in the cloud 4 or due to the storage possibility of the jobs 9,10 in the cloud 4, respectively, the job 9,10 for the workpiece processing can be downloaded by the web-based database 17 or cloud 4, respectively, directly from the laser device or the laser unit 2, respectively, wherein before the start of the download or during the download, the location of the laser device 2 or of the laser unit 2, respectively, is determined or queried, respectively, whereupon the applicable policies of the safety settings and, if necessary, further settings or parameters, respectively, for the determined location, in particular the country or region, respectively, are determined and the associated parameters, in particular so-called safety parameters, are checked in the job 9,10 and, if necessary, adjusted, i.e., that the jobs 9, 10 in the job database 17 are assigned to the individual laser units 2, which are successively processed, wherein these are adapted according to the processing location to the policies prescribed there. Thus, an automatic or manual download of the job 9,10 can be performed, and the user 5-7 does not have to make any further adaptations.

Preferably, the jobs 9,10 are downloaded manually, since the operator of the laser unit 2 usually has to insert the workpiece 12,13 into the processing chamber of the laser unit 2. However, if the laser 2 has an automatic feeding device and an automatic removal device, the laser can independently load and process the jobs 9,10 assigned to it.

This enables the customer or user 5-7, respectively, to prepare his/her files, i.e. the jobs 9,10, for the laser 2 anywhere in the world and then go to the device and retrieve them there and process them immediately. Automatic adaptation of the job 9,10 to site regulations ensures compliance with all machine safety policies.

This makes it possible for the first time for jobs 9,10 to be generated in the web-based software 1 or operator software 1, respectively, independently of the laser units 2 and location, and to be exchanged between all possible laser devices 2 or laser units 2, respectively, and locations without additional adjustments by the user 5-7, wherein whenever a laser type is changed, for example from a galvo marking laser 2b to a laser plotter 2a, a recalculation is performed by the analysis tool 14 to adjust the movement parameters. This is made possible by an open format of programming called “MIP”. This is a text-based command language for lasers 2, in which metadata (number of instructions, control of peripherals such as: extractions, etc.)+machine commands are included. Here, the exchange of jobs 9,10 between different types of machines, i.e., a laser plotter 2a and a gravo marking laser 2b, for the analysis tool 14 is based on the following aspects:
A central material database 16 (e.g. the cloud 4)
Absolute parameters and no percentages, as known from the prior art
A central exchange option of jobs 9, 10 via the cloud 4
An intelligence that transforms material parameters between devices 2
Standardization of the devices 2 to each other,
As well as the location for the policies

Furthermore, it is possible for the customer or user 5-7, respectively, to import his/her own files, in particular self-created graphics or text or old jobs, into the central web-based operator software 1. During import into the laser software or operator software 1, respectively, the graphics or text are automatically prepared for the laser process in the best possible way and any defective areas are repaired with regard to the laser process without any further action on the part of the user 5-7. The user 5-7 does not need to prepare the files in a manual and time-consuming way.

In this process, imported files are checked for possible defective points by the operator software, in particular the analysis tool:
Incompletely closed contours on which the laser would stop unintentionally.
Unconnected elements
Intersections of geometries
Changes in directions of adjacent elements
Duplications of identical elements are reduced to a single entity
Sub-graphics are reduced to a single graphic

This reduces the machine movement and cycle time significantly.

Thus, it can be said that a new usage is provided to the customer or user 5-7, respectively, which enables even untrained users 5-7 to use it immediately. Laser settings such as laser power or speed are abstracted to such an extent that no explicit basic technical understanding is required to use the laser machine 2; customers or users 5-7, respectively, only need to select the material to be processed, material thickness, effect (desired quality) and cutting effect to have all other parameters 15 determined by the analysis tool 14. For the convenience of the user 5-7, the effects 15c may comprise the following selection items: “Fine-detail engraving”, “High-contrast engraving”, “Photo engraving”, “Deep engraving”, “Fast cutting”, “Precise cutting”, “ . . . ”. It is also possible to have colors or layers assigned to a desired material effect, as known from the prior art.

However, the cloud 4 is also used to operate and control a laser device 2 for engraving, marking, lettering and/or cutting a preferably flat workpiece. In this case, the job 9,10 for the workpiece processing is downloaded from a web-based database 17 or cloud 4, respectively, directly by the laser device 2 or laser unit 1, respectively, in particular the laser plotter 2a and/or galvo marking laser 2b, wherein before the start of the download or during the download, the location of the laser is determined or queried, respectively, whereupon the applicable policies of the safety settings and, if necessary, further settings or parameters, respectively, for the determined location, in particular the country or region, respectively, are determined and the associated parameters, in particular so-called safety parameters, are checked in the job and, if necessary, adjusted, i.e., depending on the country or region, respectively, the downloaded job 9,10 is automatically adapted to the policies applicable there for processing the workpiece 12,13 by a laser, so that the user no longer has to make any adjustments. It has turned out advantageous that the determined policies for the various locations, in particular countries or regions, respectively, are stored in a web-based database 17 or in the cloud 4, respectively.

As a matter of form, it should finally be emphasized that, for the better understanding of the structure of the engraving workflow 1 and its components or constituent parts, respectively, the same have in part been represented not to scale and/or enlarged and/or reduced in size, and above all only schematically.

In addition, individual features or feature combinations from the various exemplary embodiments shown and described can inherently form independent inventive solutions or solutions according to the present invention.

1-13. (canceled)

14. A method for operating and controlling a laser device for engraving, marking, lettering and/or cutting a flat workpiece, in which at least one beam source in the form of a laser is used in a housing of the laser device, wherein the workpiece is deposited in a defined manner on a processing table in the processing chamber of the housing, and a laser beam emitted by the beam source sent via deflecting elements to at least one focusing unit, by which the laser beam is deflected in the direction of the workpiece and focused for processing, wherein position control of the workpiece relative to the laser beam is effected via a control software running in a control unit having a computer processor, in which the control software a so-called job is processed, so that the workpiece is processed line by line by adjustment of a movement system, wherein in that the job for the workpiece processing is generated by a web-based database or cloud, directly from the laser device, wherein before the start of the download or during the download the location of the laser device is determined or queried, whereupon valid policies of safety settings and, if necessary, further settings or parameters, for the determined location, in particular of the country or region, are determined and the associated parameters are checked in the job and adapted if necessary.

15. The method according to claim 14, wherein the movement system is a carriage in the case of a laser plotter or an angular adjustment in the case of a galvo marking laser.

16. The method according to claim 14, wherein the adaptation of the job for the valid policies of the safety settings includes the parameter “suction power” and/or “extraction with filter”.

17. The method according to claim 14, wherein the adaptation of the job for the valid policies of the safety settings includes the parameter “filter saturation”.

18. The method according to claim 14, wherein, when the downloaded job is started on the laser device, the existing equipment or components are checked against the parameters for the safety settings.

19. The method according to claim 18, wherein, in case of any deviations of the determined equipment or components with the predetermined settings of the parameters, a warning is output and the job is not started.

20. The method according to claim 19, wherein, when a warning is present, a special release by an authorized person is required, wherein a confirmation requires an input of a code or password, to start the job.

21. The method according to claim 20, wherein the release of the job is documented and stored despite the goods note preferably for the warranty policy of the manufacturer, wherein the storage is done in the cloud or in the web-based database.

22. The method according to claim 14, wherein, in order to create the job, the latter is generated by a central operator software for various laser types, in particular laser plotters or galvo marking lasers, for engraving, marking, lettering, and/or cutting of a flat workpiece, wherein in the central operator software a graphic and/or text is created or imported, whereupon in the central operator software for the creation of the job the parameters “material type, material thickness, engraving depth and/or effect, and cutting effect” are set, whereupon a laser type—laser plotter or galvo marking laser—is suggested or determined, by the central operator software, or the desired laser type—laser plotter or galvo marking laser—is selected by the user, whereupon, after selection of the laser type, the movement parameters of the selected laser type required for the generation of the graphics and/or text are determined or calculated and defined by an analysis tool and, after completion of the job, this is stored in a web-based database or cloud.

23. The method according to claim 22, wherein the central operator software is invoked via a higher-level network, in particular in a cloud, wherein the available laser types, in particular laser units, are likewise connected or being connected to the cloud.

24. The method according to claim 14, wherein the determined policies for the individual locations, in particular countries or regions, are stored in a web-based database or in the cloud.

25. The method according to claim 14, wherein the job is loaded and processed simultaneously by one or more laser units of the same and different locations.

26. The method according to claim 14, wherein, when the job is changed at a laser unit, these changes are made available to the further laser units processing this job.

27. The method according to claim 14, wherein, when a laser unit is connected to the web-based database or the cloud, all settings/parameters and the location concerning this laser unit are automatically uploaded and stored.
